(19) United States
(12) Patent Application Publication
(10) Pub. No.: US 2021/0003093 A1
(43) Pub. Date: Jan. 7, 2021

(54) ENGINE

(71) Applicant: HONDA MOTOR CO., LTD., Tokyo (JP)

(72) Inventors: Soji KASHIMA, Saitama (JP); Toshiro KIURA, Saitama (JP); Kota TOKUBI, Saitama (JP)

(73) Assignee: HONDA MOTOR CO., LTD., Tokyo (JP)

(21) Appl. No.: 16/982,777

(22) PCT Filed: Mar. 30, 2018
(86) PCT No.: PCT/JP2018/013847

§ 371 Date: Sep. 21, 2020

(51) Int. Cl. F02F 7/00; F01L 1/18

(52) U.S. Cl. CPC F02F 7/0004; F01L 1/18; F01L 1/146; F02F 7/0053; F02F 7/006

(57) ABSTRACT

An engine (E) includes a crankcase body (19), a crankcase cover (20) covering a case opening portion (19b) of the crankcase body (19), a crankshaft (2), a cylinder base portion 21a located inside the crankcase body (19), a cylinder block (21b) located outside the crankcase body (19). The crankcase cover (20) is detachably attached to an upper portion of the crankcase body (19).

### TECHNICAL FIELD

The present invention relates to an engine which can be mounted on a working machine such as a lawn mower or a high pressure washer.

### BACKGROUND ART

Generally, an engine includes a crankcase having first and second bearing portions which support both ends of a crankshaft and a cylinder into which a piston is fitted. For example, Patent Literature 1 discloses an engine in which a crankcase is formed of first and second case half bodies which are joined to each other at a dividing surface which diagonally intersects axes of first and second bearing portions and a cylinder and the first bearing portion are integrally formed on the first case half body, and further the second bearing portion is integrally formed on the second case half body.

Related Art Literature Patent Literature

Patent Literature 1: JP-A 2017-160833

### SUMMARY OF THE INVENTION

### Problem that the Invention is to Solve

However, in the engine structure of Patent Literature 1, the second case half body is to be removed at the time of maintenance of the engine, and when removing the second case half body, a case opening faces downward, so it is necessary to lower the engine from the frame and disassemble the engine with the case opening facing upward. As a result, there is a problem that the number of man-hours is increased.

The invention provides an engine which can reduce the number of man-hours required for maintenance.

### Means for Solving the Problem

The invention is an engine which includes:

a crankcase body including a bottom portion including a first crankshaft insertion hole and a tubular portion including the bottom portion integrally formed at one end in a first direction and including a case opening portion at the other end in the first direction:

a crankcase cover including a second crankshaft insertion hole and covering the case opening portion of the crankcase body;

a crankshaft inserted through the first crankshaft insertion hole and the second crankshaft insertion hole;

a cylinder base portion located inside the crankcase body, and

a cylinder block located outside the crankcase body, where

the first direction is an up-down direction of the engine, and

the crankcase cover is detachably attached to an upper portion of the crankcase body.

### Advantages of the Invention

According to the invention, the crankcase cover is detachably attached to the upper portion of the crankcase body. Therefore, by removing the crankcase cover during maintenance of the engine, it is possible to access the inside of the crankcase body from the top.

### BRIEF DESCRIPTION OF DRAWINGS

FIG. 1 is a cross-sectional view of an engine according to an embodiment of the invention.

FIG. 2 is a perspective view of the engine with a top cover removed, as viewed from diagonally above and front.

FIG. 3 is an exploded perspective view of the engine as seen from diagonally above and front.

FIG. 4 is an exploded perspective view of an engine body as viewed from diagonally above and front.

FIG. 5 is a plan view of the engine with a crankcase cover removed.

FIG. 6 is a cross-sectional view taken along the line A-A of FIG. 5.

FIG. 7 is a perspective view of a valve mechanism of the engine as viewed from diagonally above and front.

FIG. 8 is an exploded perspective view of the valve mechanism of the engine as viewed from diagonally above and front.

### MODE FOR CARRYING OUT THE INVENTION

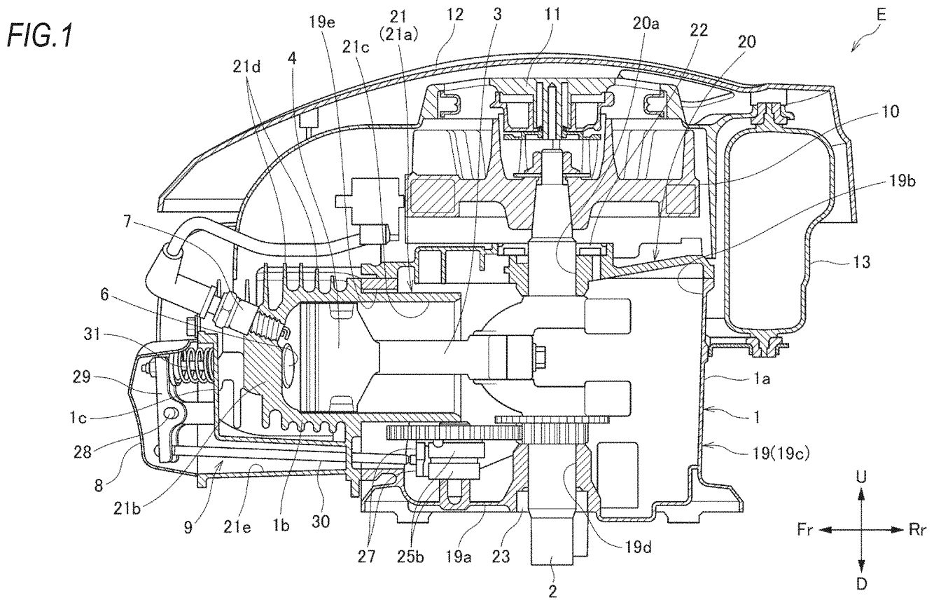

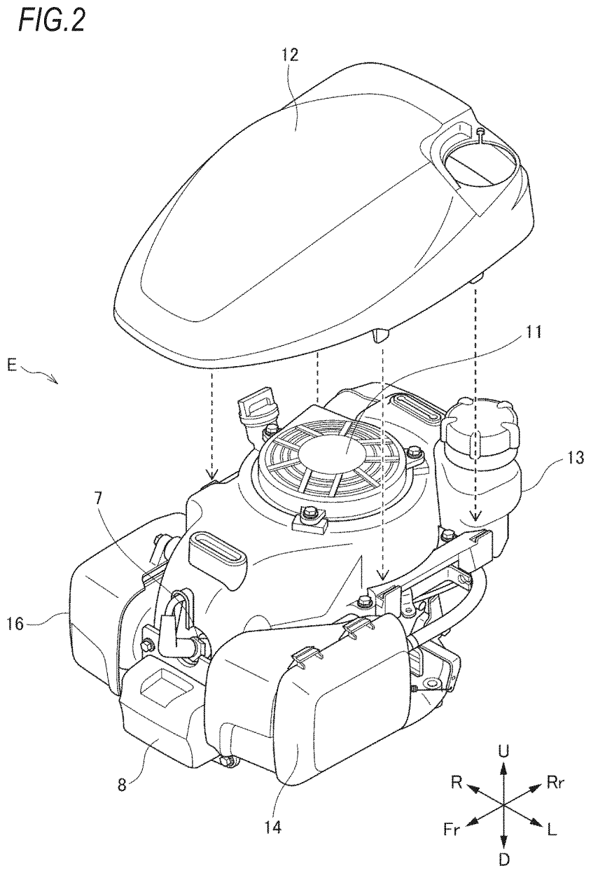

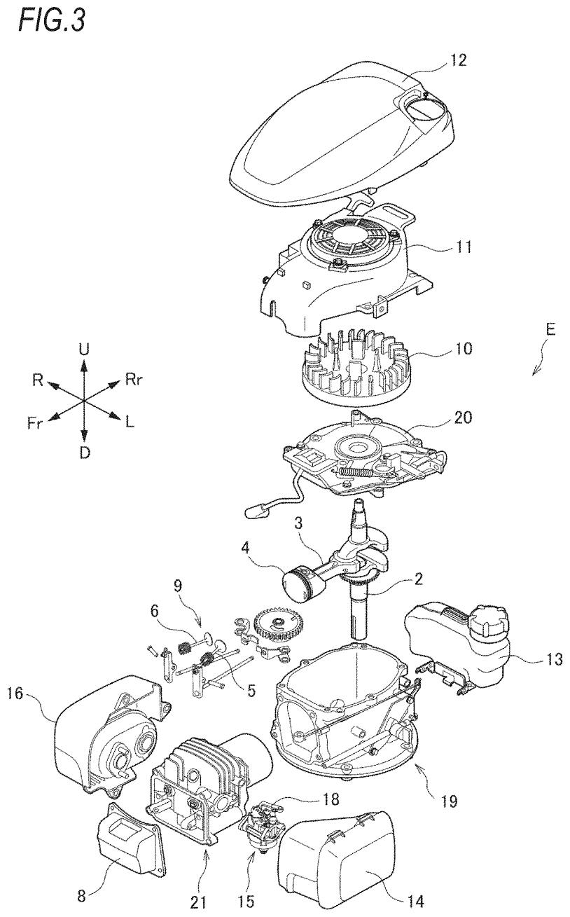

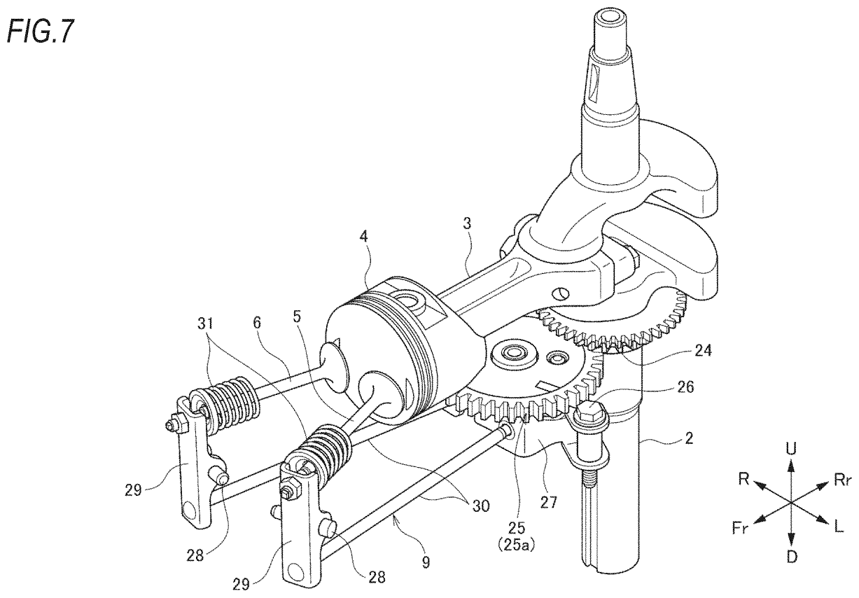

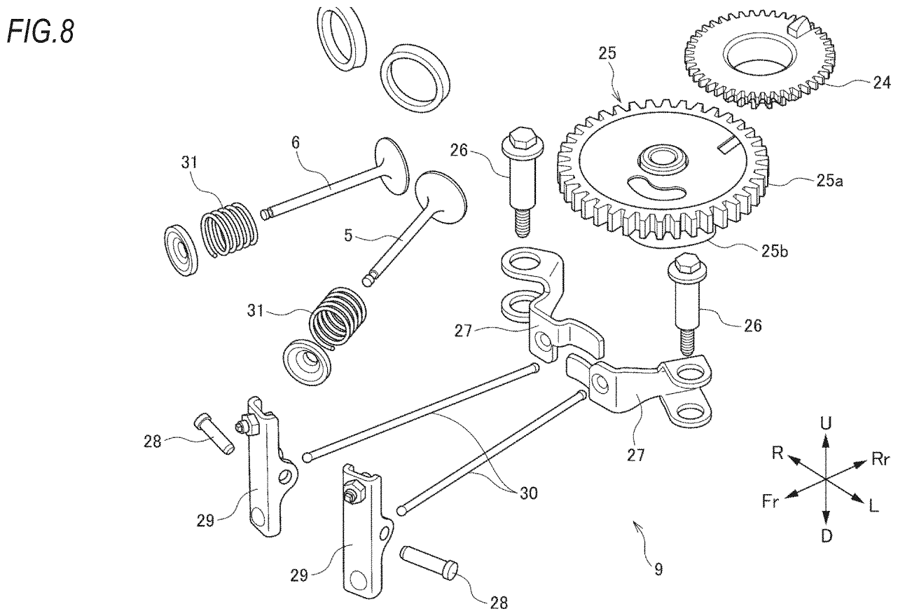

Hereinafter, an embodiment of the invention will be described with reference to FIGS. 1 to 8. An engine E of the embodiment is a small general-purpose engine mounted on a walk-type lawnmower or the like and constitutes an OHV engine. In the present specification and the like, in order to simplify and clarify the explanation, an axial direction of a crankshaft 2 is defined as an up-down direction (first direction), a direction which is perpendicular to the up-down direction and in which a cylinder portion 1b extends is defined as a front-back direction (second direction), and a direction perpendicular to the up-down direction and the front-back direction is defined as a left-right direction. In the drawing, the front of the engine E is shown as Fr, the rear as Rr, the left as L, the right as R the upper as U, and the lower as D.

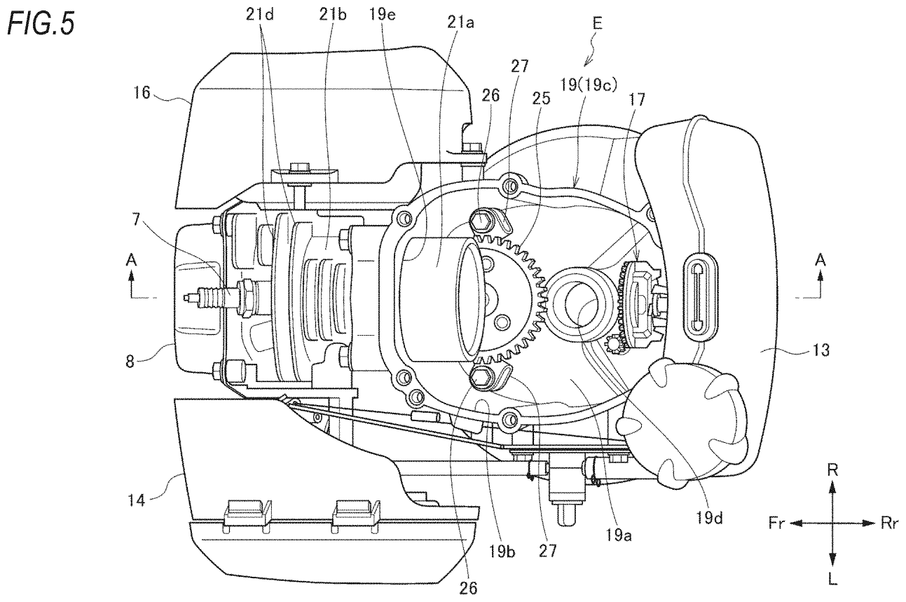

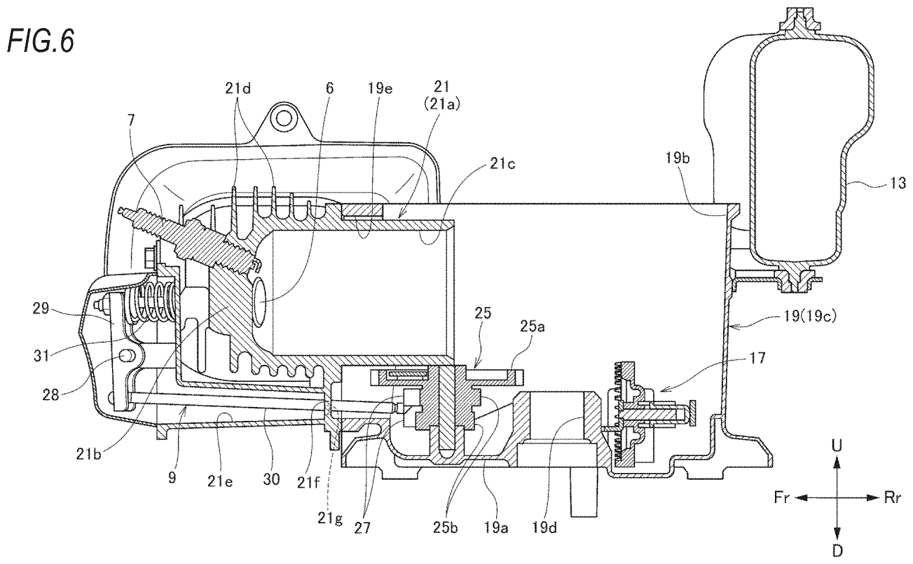

As illustrated in FIGS. 1 to 3. the engine E of the embodiment includes an engine body 1 including a crankcase portion 1a and the cylinder portion 1b, the crankshaft 2 which is rotatably supported by the crankcase portion 1a in the up-down direction, a piston 4 slidably fitted in the cylinder portion 1b and connected to the crankshaft 2 via a connecting rod 3, an intake valve 5, an exhaust valve 6, and a spark plug 7 provided in a head portion 1c of the cylinder portion 1b, a head cover 8 for covering the head portion 1c of the cylinder portion 1b, a valve mechanism 9 which operates the intake valve 5 and the exhaust valve 6 according to the rotation of the crankshaft 2, a flywheel 10 connected to an upper end of the crankshaft 2, a recoil starter 11 which is placed above the flywheel 10 and starts the engine E, a top cover 12 which covers the top of engine E, a fuel tank 13 for storing fuel, an air cleaner 14 which purifies the air, a carburetor 15 which produces and supplies a mixture of fuel and air to the cylinder portion 1b, a muffler 16 which exhausts the exhaust gas from the cylinder portion 1b while muffling the gas, a governor mechanism 17 (see FIGS. 5 and 6) which automatically opens and closes a throttle valve (not illustrated) of the carburetor 15 according to the rotation speed of the crankshaft 2, and an auto choke mechanism 18 which automatically opens and closes the throttle valve of the carburetor 15 according to the temperature of the engine body 1.

[Engine Body]

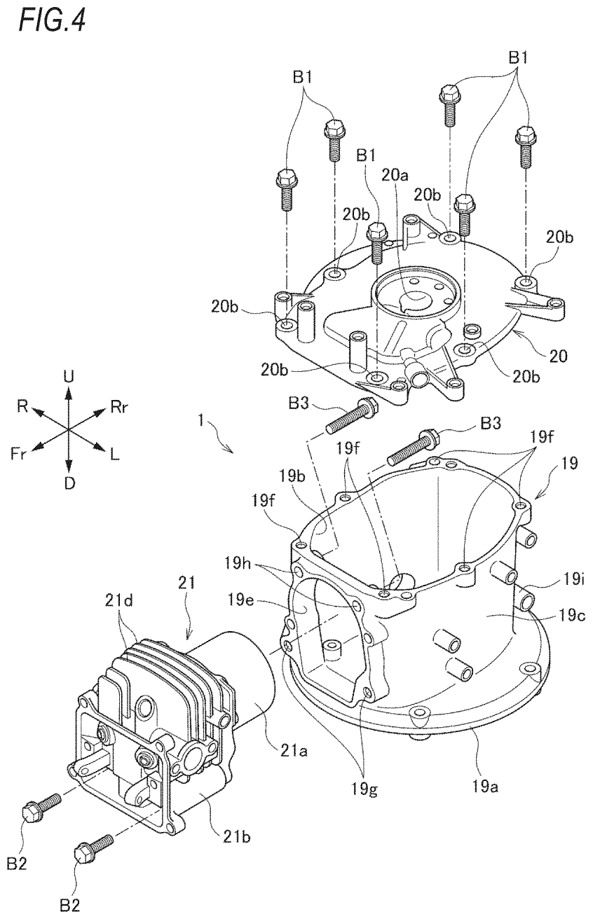

As illustrated in FIG. 4, the engine body 1 includes a crankcase body 19, a crankcase cover 20, and a cylinder unit 21.

As illustrated in FIGS. 4 to 6, the crankcase body 19 includes a bottom portion 19a and a tubular portion 19c including the bottom portion 19a integrally formed at a lower end portion and a case opening portion 19b at an upper end portion. A first crankshaft insertion hole 19d into which the lower end side of the crankshaft 2 is inserted is formed in the center of the bottom portion 19a and a cylinder insertion hole 19e through which the cylinder base portion 21a of the cylinder unit 21 is inserted is formed on the front surface of the tubular portion 19c. In FIG. 4, reference numerals and letter 19i indicate a drain opening for discharging the oil accumulated inside the crankcase portion 1a.

As illustrated in FIG. 4, the crankcase cover 20 covers the case opening portion 19b of the crankcase main body 19 and forms the crankcase portion 1a of the engine body 1 together with the crankcase main body 19. A second crankshaft insertion hole 20a into which the upper end of the crankshaft 2 is inserted is formed in the center of the crankcase cover 20. Returning to FIG. 1, the crankshaft 2 is rotatably supported between a second bearing 22 provided adjacent to the second crankshaft insertion hole 20a of the crankcase cover 20 and a first bearing 23 provided adjacent to the first crankshaft insertion hole 19d of the crankcase body 19.

The crankcase cover 20 is detachably attached to the upper end of the crankcase body 19 via a plurality of bolts B1. Specifically, a plurality of bolt insertion holes 20b, through which the bolts B1 are inserted from above, are formed in the peripheral portion of the crankcase cover 20 and a plurality of bolt fastening holes 19f into which the bolts B are fastened from above are formed in the upper end of the crankcase body 19. The crankcase cover 20 is attached to the crankcase body 19 by fastening the bolts B1 to the bolt fastening holes 19f through the bolt insertion holes 20b. Conversely, the crankcase cover 20 can be removed from the crankcase body 19 by releasing the fastening of the bolts B1 from the bolt fastening holes 19f.

According to the crankcase body 19 and the crankcase cover 20 as described above, by removing the crankcase cover 20 during maintenance of the engine E, it is possible to access the inside of the crankcase body 19 from above. In particular, when replacing the crankshaft 2, it is possible to easily replace the crankshaft 2 by removing the crankcase cover 20 and pulling out the crankshaft 2.

As illustrated in FIGS. 4 to 6, the cylinder unit 21 includes the cylinder base portion 21a which is inserted into the cylinder insertion hole 19e of the crankcase body 19 from the front and is located inside the crankcase body 19 and a cylinder block 21b which extends forward from the cylinder base portion 21a and is located outside the crankcase body 19. The cylinder unit 21 alone forms the cylinder portion 1b of the engine body 1 and the front end of the cylinder block 21b forms the head portion 1c. The cylinder base portion 21a and an inner peripheral surface of a cylindrical portion of the cylinder block 21b form a cylinder bore 21c which is a sliding surface with the piston 4 and a large number of cooling fins 21d are provided on the outer peripheral portion of the cylinder block 21b.

According to such cylinder unit 21, by preparing a plurality of types of cylinder unit 21 having different bore diameters, it becomes possible to provide an engine body 1 having a different displacement simply by replacing the cylinder unit 21 while making the crankcase body 19 and the crankcase cover 20 common.

The cylinder unit 21 is detachably attached to the crankcase body 19 via a plurality of bolts B2 and B3. For example, when a plurality of bolt insertion holes (not illustrated) through which the bolts B2 are inserted from the front are formed at the rear end of the cylinder block 21b and a plurality of bolt fastening holes 19g for fastening the bolts B2 from the front are formed at the front end of the crankcase body 19, by fastening the bolts B2 to the bolt fastening holes 19g through the bolt insertion holes of the cylinder block 21b, the cylinder unit 21 can be attached to the crankcase body 19. Conversely by releasing the fastening of the bolts B2 to the bolt fastening holes 19g, the cylinder unit 21 can be removed from the crankcase body 19.

However, in the engine body 1 of the embodiment, when the cylinder unit 21 is detachably attached to the crankcase body 19 via the plurality of bolts B2 and B3, the bolts B3 on the upper end side is fastened to the cylinder unit 21 from the inside of the crankcase body 19. Specifically, a plurality of bolt insertion holes 19h through which the bolts B3 are inserted from the inside of the crankcase body 19 toward the front are formed in the front end of the crankcase body 19 and a plurality of bolt fastening holes (not illustrated) for fastening the bolts B3 from the rear are formed at the rear end of the cylinder block 21b, and further the bolts B3 is fastened to the bolt fastening holes of the cylinder block 21b through the bolt insertion holes 19h of the crankcase body 19.

According to such a mounting structure of the cylinder unit 21, since it is not necessary to form a space for fastening the bolts B3 from the front side at least on the upper end side of the cylinder block 21b, the cylinder unit 21 can be attached to the crankcase body 19 without disturbing the external structure (for example, the cooling fin 21d) of the cylinder block 21b, and thus the cooling performance of the engine E can be improved.

[Valve Mechanism]

As illustrated in FIGS. 6 to 8, the valve mechanism 9 includes a timing gear 24 fixed to the crankshaft 2, a camshaft 25 rotatably supported on the bottom portion 19a of the crankcase body 19, a pair of lifters 27 supported to be swingable on the bottom portion 19a of the crankcase body 19 via stepped bolts 26, a pair of rocker arms 29 which are supported to be swingable at the front end of the cylinder block 21b via rocker arm shafts 28 and one end of which abuts the front end of the intake valve 5 or the exhaust valve 6, a pair of push rods 30 which are accommodated in a push rod accommodation portion 21e formed in the lower part of the cylinder unit 21 and which respectively connect the lifters 27 to the other end portions of the pair of rocker arms 29, and a pair of valve springs 31 for urging the intake valve 5 and the exhaust valve 6 in a closing direction.

A camshaft 25 includes a gear portion 25a which meshes with the timing gear 24 and is rotationally driven by the timing gear 24 at a speed reduction ratio of 1/2 and a cam portion 25b which alternately pushes the pair of lifters 27 according to the rotational drive of the gear portion 25a. When the cam portion 25b pushes the lifter 27, the other end of the corresponding rocker arm 29 is pushed through the push rod 30 and the intake valve 5 or the exhaust valve 6 connected to one end of the rocker arm 29 is opened. Conversely, when the pushing of the lifter 27 by the cam portion 25b is released, the intake valve 5 or the exhaust valve 6 is closed by the urging force of the valve spring 31.

The camshaft 25 of the embodiment is arranged below the cylinder base portion 21a of the cylinder unit 21. When the camshaft 25 is arranged as such, it is possible to access the inside of the crankcase body 19 from the top without removing the camshaft 25 by simply removing the crankcase cover 20 when maintaining the engine E.

In FIG. 6, reference numerals and letter 21g indicate a communication hole provided in a rear wall 21f of the push rod accommodation portion 21e. The communication hole 21g is provided at the lowest position when the oil accumulated inside the crankcase portion 1a is drained from a drain opening 19i of the crankcase body 19 to the outside. The communication hole 21g guides the oil accumulated in the head portion 1c and the push rod accommodation portion 21e to the crankcase portion 1a. Therefore, it is possible to more reliably prevent the accumulation of oil in the push rod accommodation portion 21e when the oil is discharged.

The embodiment described above can be appropriately modified, improved, and the like. For example, in the embodiment described above, the front-back direction is described as the second direction, but the second direction may be the left-right direction.

Although the cylinder unit 21 is detachable from the crankcase body 19 in the embodiment described above, the cylinder unit 21 may be formed integrally with the crankcase body 19.

### SUMMARY

At least the following matters are described in the specification. Although the constituent elements and the like corresponding to those of the embodiment described above are shown in parentheses, the invention is not limited to this.

(1) An engine which includes:

a crankcase body (crankcase body 19) including a bottom portion (bottom portion 19a) including a first crankshaft insertion hole (first crankshaft insertion hole 19d) and a tubular portion (tubular portion 19c) including the bottom portion integrally formed at one end in a first direction and including a case opening portion (case opening portion 19b) at the other end in the first direction:

a crankcase cover (crankcase cover 20) including a second crankshaft insertion hole (second crankshaft insertion hole 20a) and covering the case opening portion of the crankcase body;

a crankshaft (crankshaft 2) inserted through the first crankshaft insertion hole and the second crankshaft insertion hole:

a cylinder base portion (cylinder base portion 21a) located inside the crankcase body; and

a cylinder block (cylinder block 21b) located outside the crankcase body, where

the first direction is an up-down direction of the engine (engine E), and

the crankcase cover is detachably attached to an upper portion of the crankcase body.

According to (1), the crankcase cover is detachably attached to the upper portion of the crankcase body. Therefore, by removing the crankcase cover during maintenance of the engine, it is possible to access the inside of the crankcase body from the top. In particular, when replacing the crankshaft, it is possible to easily replace the crankshaft by removing the crankcase cover and pulling out the crankshaft.

(2) The engine according to (1), where

a camshaft (camshaft 25) is installed inside the crankcase body, and

the camshaft is arranged further on a lower side than the cylinder base portion.

According to (2), the camshaft is located below the cylinder base portion. Therefore, by simply removing the crankcase cover during engine maintenance, it is possible to access the inside of the crankcase body from the top without removing the camshaft.

(3) The engine according to (1) or (2), where

the engine includes a valve mechanism (valve mechanism 9),

the valve mechanism includes,

a timing gear (timing gear 24) fixed to the crankshaft,

a camshaft (camshaft 25) rotatably supported by the bottom portion of the crankcase body,

a pair of lifters (lifters 27) supported to be swingable on the bottom portion of the crankcase body,

a pair of rocker arms (rocker arms 29) which are supported to be swingable via rocker arm shafts (rocker arm shafts 28) and one end of which abuts against an intake valve (intake valve 5) or an exhaust valve (exhaust valve 6),

a pair of push rods (push rods 30) for connecting the pair of lifters to the other ends of the pair of rocker arms, and

a pair of valve springs (valve springs 31) for urging the intake valve and the exhaust valve in a closing direction, and

the pair of push rods are accommodated in a push rod accommodation portion (push rod accommodation portion 21e) formed in a lower portion of the cylinder block.

According to (3), the pair of push rods of the valve mechanism are accommodated in the push rod accommodation portion formed in the lower portion of the cylinder block. Therefore, by simply removing the crankcase cover during engine maintenance, it is possible to access the inside of the crankcase body from the top without removing the push rod. Since the push rod accommodation portion is integrally formed in the lower portion of the cylinder block, the number of parts can be reduced. As a result, the manufacturing cost can be reduced.

(4) The engine according to (3), where

the push rod accommodation portion is provided with a communication hole (communication hole 21g) communicating with the inside of the crankcase body.

According to (4), the oil accumulated in the push rod accommodation portion flows into the crankcase body through the communication hole, so that the accumulation of oil in the push rod accommodation portion can be prevented.

(5) The engine according to (4), where

the communication hole is provided at the lowest position when oil accumulated inside the crankcase body is discharged to the outside from a drain opening (drain opening 19i) of the crankcase body.

According to (5), since the communication hole is provided at the lowest position when the oil accumulated inside the crankcase body is discharged to the outside from the drain opening of the crankcase body. Therefore, it is possible to more reliably prevent oil from accumulating in the push rod accommodation portion during oil discharge.

### DESCRIPTION OF REFERENCE NUMERALS AND CHARACTERS

E: engine
2: crankshaft
5: intake valve
6: exhaust valve
9: valve mechanism
19: crankcase body
19a: bottom portion
19b: case opening portion
19c: tubular portion
19d: first crankshaft insertion hole
19e: cylinder insertion hole
19i: drain opening
20: crankcase cover
20a: second crankshaft insertion hole
21: cylinder unit
21a: cylinder base portion
21b: cylinder block
21g: communication hole
21e: push rod accommodation portion
24: timing gear
25: camshaft
27: lifter
28: rocker arm shaft
29: rocker arm
30: push rod
31: valve spring

1. An engine comprising:
a crankcase body including a bottom portion including a first crankshaft insertion hole and a tubular portion including the bottom portion integrally formed at one end in a first direction and including a case opening portion at the other end in the first direction;
a crankcase cover including a second crankshaft insertion hole and covering the case opening portion of the crankcase body;
a crankshaft inserted through the first crankshaft insertion hole and the second crankshaft insertion hole;
a cylinder base portion located inside the crankcase body; and
a cylinder block located outside the crankcase body, wherein:
the first direction is an up-down direction of the engine; and
the crankcase cover is detachably attached to an upper portion of the crankcase body.

2. The engine according to claim 1, wherein:
a camshaft is installed inside the crankcase body; and
the camshaft is arranged further on a lower side than the cylinder base portion.

3. The engine according to claim 1, wherein:
the engine includes a valve mechanism;
the valve mechanism includes:
a timing gear fixed to the crankshaft;
a camshaft rotatably supported by the bottom portion of the crankcase body;
a pair of lifters supported to be swingable on the bottom portion of the crankcase body;
a pair of rocker arms which are supported to be swingable via rocker arm shafts and one end of which abuts against an intake valve or an exhaust valve;
a pair of push rods for connecting the pair of lifters to the other ends of the pair of rocker arms; and
a pair of valve springs for urging the intake valve and the exhaust valve in a closing direction; and
the pair of push rods are accommodated in a push rod accommodation portion formed in a lower portion of the cylinder block.

4. The engine according to claim 3, wherein
the push rod accommodation portion is provided with a communication hole communicating with the inside of the crankcase body.

5. The engine according to claim 4, wherein
the communication hole is provided at the lowest position when oil accumulated inside the crankcase body is discharged to the outside from a drain opening of the crankcase body.
